(19) United States
(12) Patent Application Publication
(10) Pub. No.: US 2026/0254753 A1
(43) Pub. Date: Aug. 27, 2026

(54) VIRTUAL GATEWAY APPLIANCES

(71) Applicant: Hewlett Packard Enterprise Development LP, Spring, TX (US)

(72) Inventors: Geoffery A. Schunicht, Spring, TX (US); Tebe Tensing, Bangalore (IN)

(21) Appl. No.: 19/185,801

(22) Filed: Apr. 22, 2025

(30) Foreign Application Priority Data
Feb. 25, 2025 (IN) 202511016651

(51) Int. Cl. H04L 45/586; H04L 45/00; H04L 45/02; H04L 12/66

(52) U.S. Cl. CPC H04L 45/586; H04L 45/02; H04L 45/22; H04L 12/66

(57) ABSTRACT

A system includes a plurality of servers. Each server includes a baseboard management controller, and each baseboard management controller communicates an associated network traffic flow with a central management server. A virtual gateway appliance of the system includes an aggregator engine. The aggregator engine routes the network traffic flows through respective first persistent network connections associated with respective baseboard management controllers. The aggregator engine provides a second persistent network connection with the central management server, and the aggregator engine multiplexes the network traffic flows to route the network traffic flows through the second persistent network connection.

### BACKGROUND

A server may include a specialized service processor, called a "baseboard management controller," or "BMC," which monitors the physical state of the server and communicates with a management system through a management network. As examples of its roles, a BMC may monitor sensors (e.g., temperature sensors, cooling fan speed sensors and tampering sensors); monitor an operating system status; monitor a power status; log system events; and provide remotely-controlled management functions for the server. Moreover, a BMC may operate on auxiliary power to allow operations to be performed when a main power supply of the server is turned off.

### BRIEF DESCRIPTION OF THE DRAWINGS

FIG. 1 is a block diagram of a system of managed servers, which includes a secure virtual gateway appliance that forms a secure persistent network connection with a remote central management server and directs bidirectional network traffic affiliated with multiple baseboard management controllers through the secure persistent network connection, according to an example implementation.

FIG. 2 is a block diagram of a secure virtual gateway appliance according to an example implementation.

FIG. 3 is a flow diagram depicting a technique used by a central management server to update a secure virtual gateway appliance, according to an example implementation.

FIG. 4 is a block diagram of a high availability (HA) virtual gateway appliance architecture according to an example implementation.

FIG. 5 is a block diagram of a system that includes a virtual gateway appliance having an aggregator engine to provide a persistent connection with a central management server and multiplex network traffic flows associated with respective baseboard management controllers through the persistent connection, according to an example implementation.

FIG. 6 is a flow diagram depicting a technique used by a central management service to update a virtual gateway appliance according to an example implementation.

FIG. 7 is an illustration of hardware processor-readable instructions stored on a non-transitory storage medium, which, when executed by a hardware processor, cause a virtual gateway appliance to provide a persistent connection with a central management server and multiplex network traffic flows associated with respective baseboard management controllers through the persistent connection, according to an example implementation.

### DETAILED DESCRIPTION

A BMC of a server (called a "managed server" herein) may communicate bidirectional management-related network traffic with a remote management server. For this purpose, in one approach, the BMC may establish one or multiple network connections with the remote management server. The network traffic corresponds to messaging and content communicated between the BMC and the remote management server.

In an example, a BMC may establish a secure persistent network connection (e.g., a WebSocket Secure (WSS) connection) with a remote management server. A persistent network connection endures for multiple request-response transactions and may last for minutes, hours, if not days or even longer. In an example, network traffic communicated through a persistent network connection may correspond to inquiries, by the remote management server, about the managed server's inventory and the managed server's responses to the inquiries. In another example, network traffic communicated through a persistent network connection may be associated with operations, initiated by the remote management server, to configure the managed server. In another example, network traffic communicated through a persistent network connection may be associated with operations, initiated by the remote management server, to set up virtual media for the managed server. In another example, network traffic communicated through a persistent network connection may be associated with the management of the managed server's power state.

In another example, a BMC may establish a secure short-lived network connection (e.g., a Hypertext Transfer Protocol Secure (HTTPS) connection) with a remote management server. A short-lived network connection endures for a single request-response transaction. In an example, a BMC may, through a short-lived network connection, send a message to a remote management server to report an event (e.g., report an out-of-range temperature measurement, a hardware component failure, a system boot event or a tampering detection). In another example, a BMC may, through a short-lived network connection, request and receive a firmware update.

A cloud-based remote management server (called a "central management server" herein) may provide management services (e.g., compute operations management, or "COM," services) for an on-site system of managed servers, such as a collection of servers that are physically located at a particular geographical location, or site (e.g., a collection of servers located in a private data center or a co-location data center). In examples, the management services may include any of a number of services for the servers, including inventory monitoring and management; health monitoring; security monitoring; system firmware management and update automation; BMC firmware management and update automation; and operating system management and update automation.

In one approach, the management services rely on network connections between the respective BMCs of the managed servers and the central management server. However, the on-site system's networking infrastructure may not be natively set up to allow network connections between the BMCs and the central management server. For example, setting up the network infrastructure to allow a network connection for a particular BMC may involve a process called "hole punching," which includes a system administrator modifying firewall rules and/or proxy settings of the network infrastructure. Although configuring the networking infrastructure to allow a single BMC to form a network connection with the central management server may be an arduous task, configuring the networking infrastructure to allow a large number (e.g., hundreds if not thousands) of BMCs to form network connections with the central management server may be rather impractical. Moreover, punching a hole through a firewall may be considered a security risk, and as such, a networking security policy may prohibit this practice.

In accordance with example implementations that are described herein, a system of managed servers is associated with a particular geographical location, or site, and the managed servers include respective BMCs. Each BMC communicates bidirectional network traffic with a remote, central management server. The BMCs, however, do not establish network connections with the central management server. Instead, the BMCs establish secure network connections with a local secure virtual gateway appliance. For example, a given BMC establishes a secure persistent network connection with the secure virtual gateway appliance, and over time, the given BMC may establish secure short-lived network connections with the secure virtual gateway appliance. The secure virtual gateway appliance forms a secure persistent network connection with the central management server. In this context, the "local" nature of the secure virtual gateway appliance refers to the appliance being connected to a network fabric (e.g., a private network fabric) that is co-located at the same geographical site with the servers (and BMCs).

The secure virtual gateway appliance aggregates the network traffic for all of the BMCs and directs the aggregated traffic through the appliance's persistent network connection with the central management server. In this manner, the secure virtual gateway appliance receives, through the secure network connections with the BMCs, ingress traffic flows that are generated by the BMCs. The secure virtual gateway appliance multiplexes, or aggregates, the ingress network traffic flows to provide a consolidated egress network traffic flow. Through the persistent network connection between the secure virtual gateway appliance and the central management server, the consolidated egress network traffic flow exits the secure virtual gateway appliance and is received by the central management server. The secure virtual gateway appliance also receives, through the persistent network connection between the secure virtual gateway appliance and the central management server, a consolidated ingress flow that is sent by the central management server. The secure virtual gateway appliance demultiplexes, or disaggregates, the consolidated ingress network flow into individual egress network traffic flows for the respective BMCs. The secure virtual gateway appliance sends the individual egress network traffic flows to the respective BMCs via the secure network connections between the BMCs and the secure virtual gateway appliance.

Due to the reduction of network connections between the BMCs and the central management server, firewall and proxy configurations for the local networking infrastructure are greatly simplified. Moreover, as further described herein, the secure virtual gateway appliance may be updated by the central management server without any involvement or initiation by users (e.g., system administrators and end users of applications hosted by the managed servers) affiliated with the system of managed servers. In this way, as further described herein, the central management server may add, modify and delete microservices of the virtual gateway appliance in a manner that is transparent to the users.

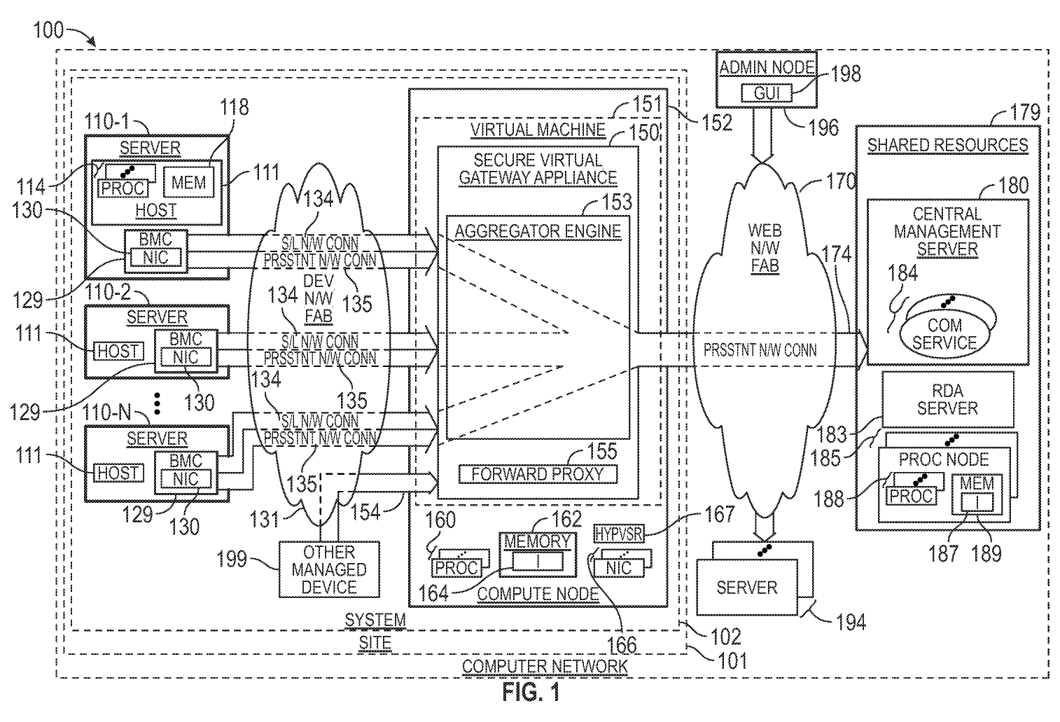

Referring to FIG. 1, as a more specific example, a computer network 100 includes a remote, central management server 180 (called the "central management server 180" herein) and a system 102 of N servers 110 (called "managed servers 110" herein) that are managed by the central management server 180. Example managed servers 110-1, 110-2 and 110-N are depicted in FIG. 1. In an example, the central management server 180 is hosted on shared resources 179 (e.g., public cloud resources). The system 102 is affiliated with a particular geographical location, or site 101. In an example, the system 102 may be located in a particular facility, such as a data center (e.g., a private, on-premise data center or a co-location data center). In an example, the system 102 corresponds to a private cloud. In another example, the system 102 corresponds to an edge computing system. In examples, the managed servers 110 may be a collection of rack servers, blade servers, tower servers or a combination of the foregoing.

The central management server 180, in accordance with example implementations, provides a number of COM services 184 for the servers 110. In examples, COM services 184 monitor and manage inventories (e.g., hardware inventories and/or software inventories) of the managed servers 110. In another example, a COM service 184 monitors security statuses of the servers 110. In another example, a COM service 184 monitors health statuses of the managed servers 110. In another example, a COM service 184 manages operating system versions and operating system update automation for the managed servers 110. In another example, a COM service 184 manages system firmware versions and system firmware update automation for the managed servers 110. In another example, a COM service 184 manages firmware management stack versions and firmware management stack update automation for the managed servers 110. In another example, one or multiple COM services 184 manage remotely-controlled functions for the managed servers 110, such as managing server power states, server keyboard video mouse (KVM) functions and server virtual media. In another example, one or multiple COM services 184 manage configurations of the managed servers 110.

The monitoring and management of the managed servers 110, via the COM services 184, may be aided by one or multiple graphical user interfaces (GUIs) 198 (e.g., dashboards) that are hosted on one or multiple administrative nodes 196. In an example, a system administrator may assign the managed servers 110 to one or multiple groups so that particular firmware updates and/or operating system images are installed based on group affiliation. In another example, a system administrator may power up or power down all managed servers 110 of a particular group. In another example, a system administrator may view health statuses for servers of a particular group. In another example, a system administrator may view security alerts for a particular group of managed servers 110. In other examples, a system administrator may select a specific managed server 110 for purposes of performing a specific action on the selected managed server 110, such as querying the managed server's inventory, configuring the managed server 110, upgrading the managed server's firmware, installing a new operating system image on the managed server 110, viewing security alerts for the managed server 110, viewing health alerts for the managed server 110, and so forth.

A server 110 includes a host 111 and a BMC 129 that manages the host 111. In the context that is used herein, a "host" refers to a collection of components of the server 110, which provide one or multiple application operating environments in which application workloads (corresponding to application processes ) run, or execute. In examples, the application operating environments may be bare-metal environments, virtual machines, containers, or a combination thereof. Although a single host 111 per server 110 is depicted in FIG. 1, a particular server 110 may include multiple hosts 111.

The system 102 may further include one or multiple managed devices 199 other than servers 110. These other managed devices 199 are also managed by the central management server 180, in accordance with example implementations. In general, a managed device 199 includes hardware that is mounted to a frame, or chassis, of the managed device 199; the hardware of the managed device 199 is capable of executing machine-readable instructions; and hardware of the managed device 199 includes a network interface. In examples, a managed device 199 may be a smartphone, a wearable computer, a networking component, a gateway, a network switch, a storage array, a portable electronic device, a portable computer, a tablet computer, a thin client, a laptop computer, a television, a modular switch, a consumer electronics device, an appliance, a sensor system, a watch, a removable peripheral card, or, in general, any other processor-based electronic device that has a network connection.

FIG. 1 depicts specific components of the host 111 of the managed server 110-1. The hosts 111 of the other managed servers 110 may have similar components to the host 111 of the server 110-1. The managed server 110-1 includes one or multiple processing cores 114 (e.g., one or multiple central processing unit (CPU), cores), a memory 118 and various other hardware components, such as one or multiple storage drives; one or multiple Universal Serial Bus (USB) devices; I/O devices; a video controller; and so forth. In general, the memory devices that form the memory 118, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

A BMC 129, in accordance with example implementations, includes a management plane and a security plane that is isolated from the management plane. Through its management plane, the BMC 129 provides such management-related functions as operating system runtime services; resource detection and initialization; and pre-operating system services. In other examples, the management-related functions include the BMC 129 monitoring telemetry values (e.g., cooling fan speeds and temperature measurements) and reporting unexpected or out-of-range telemetry values.

The management-related functions provided by the BMC 129 may also include remotely-controlled functions. As examples, the remotely-controlled functions include KVM functions; virtual power functions (e.g., remotely-activated functions to place a server 110 in a particular power state, such as a power conservation state, a power on state, a reset state or a power off state); virtual media management functions; a function to update a BMC configuration, a function to configure the server's storage system (e.g. a redundant array of inexpensive disks (RAID) configuration); a function to update firmware of the BMC; a function to update system firmware of the server 110; a function to capture an inventory of the server; a function to monitoring a health of the server 110; as well as one or multiple other and/or different functions to manage and configure BMCs 129, hosts 111 and the servers 129.

Through its security plane, a BMC 129 may also provide a number of security-related functions for the host 111. In an example of a security-related function, the BMC 129 validates a firmware management stack for the BMC 129 before the BMC 129 executes the stack. In another example, a security-related function, the BMC 129 anchors a cryptographic chain of trust for the managed server 110. When the host 111 boots, the BMC 129, by executing the validated firmware management stack, validates host system firmware (e.g., Unified Extensible Firmware Interface (UEFI) firmware), thereby extending the chain of trust to the host system firmware.

In another example of a security-related function, the BMC 129 manages the storage of cryptographic artifacts (e.g., certificates, keys, digital certificates and seeds) for the host 111. In other examples of security-related functions, the BMC 129 may provide cryptographic services. In examples, a cryptographic service may be a key generation service, a signature validation service, an encryption service, a decryption service, a hashing service, a true random number generation service or a deterministic random number generation (DRNG) service. In another example of a security-related function, the BMC 129 detects and reports an unexpected inventory of the host 111 (e.g., an observed inventory that is different from an inventory corresponding to a base platform certificate and any delta platform certificate(s)). In another example of a security-related function, the BMC 129 reports an attestation value (e.g., a signed measurement digest) measured in connection with a measured boot of the host 111. In another example of a security-related function, the BMC 129 monitors environmental signals (e.g., sensor signals representing a die temperature, a clock rate, a supply voltage magnitude, an enclosure opening status, a removal status, and so forth) of the server 110 for purposes of detecting tampering, and the BMC 129 reports any detected tampering events.

In accordance with example implementations, in the course of performing its management-related functions and security-related functions, a BMC 129 communicates bidirectional management network traffic with the central management server 180. In an example, the management network traffic relates to messaging, such as the communication of API request messages and API response messages between the BMC 129 and the central management server 180. In another example, the management network traffic includes content (e.g., a firmware image or an operating system image).

In an example, the management network traffic includes an event message that a BMC 129 sends to report an unexpected telemetry value (e.g., an out-of-range temperature measurement) associated with a host 111. In another example, the management network traffic includes a message that a BMC 129 sends to report a detected hardware fault associated with a host 111. In another example, the management network traffic includes a message that a BMC 129 sends to report a detected software fault associated with a host 111. In other examples, the management network traffic includes messaging related to a BMC 129 requesting and receiving a firmware upgrade package, an operating system image upgrade or a software patch.

In another example, the management network traffic includes messaging related to queries that are initiated by the central management server 180 for purposes of invoking remotely-controlled functions that are provided by the BMC 129. For example, the messaging may include an inquiry, from the central management server 180, about an inventory or a configuration of a host 111 and a corresponding response from a BMC 129. In other examples, the management network traffic includes messaging between a BMC 129 and the central management server 180 to configure a host 111, control host power (e.g., power up or power down the host 111) or manage the host's virtual media.

The management network traffic for a particular BMC 129 may include security-related messaging. In an example, a BMC 129 may send a message to the central management server 180 to report tampering with a managed server 110. In another example, the management network traffic may include a message sent by a BMC 129 to report an unexpected inventory of a host 111. In another example, the management network traffic may include a message sent by a BMC 129 to report an attestation value measured during a measured boot of a host 111. In another example, the management network traffic may include a message sent by a BMC 129 to report an unexpected measurement during a trusted boot of a host 111. In another example, the management network traffic may include a message sent by the BMC 129 to report a firmware validation failure. In another example, the management network traffic may include a message that is sent, by the central management server 180 and to a BMC 129, to add, change or delete a cryptographic artifact stored in the BMC 129. In another example, the management network traffic includes messaging between a BMC 129 and the central management server 180 to change an ownership token associated with the BMC's firmware management stack.

The BMC 129 has an associated network interface controller (NIC) 130 for purposes of sending and receiving management network traffic, which includes network traffic associated with management-related functions and security-related functions of the BMC 129. For the example implementation that is depicted in FIG. 1, the NIC 130 is a component of the BMC 129. In another example, the NIC 130 is not built into the BMC 129, and the NIC 130 corresponds to a NIC adapter that is installed in a card edge connector of the managed server 110. Continuing the example, the BMC 129 may communicate with such a NIC 130 using a sideband channel bus (e.g., a Network Controller-Sideband Intercommunication (NC-SI) bus).

Instead of the BMCs 129 establishing network connections with the central management server 180, the BMCs 129 instead establish secure network connections with a local, secure virtual gateway appliance 150 that is located on-site with the managed servers 110 and other managed device(s) 199. In this manner, each BMC 129 establishes a secure persistent network connection 135 with the secure virtual gateway appliance 150, and over time, the given BMC 129 may establish secure short-lived network connections 134 with the secure virtual gateway appliance 150. In the context that is used herein, a "network connection" refers to a communication channel between a first endpoint device (e.g., a BMC 129) associated with a first network address (e.g., an Internet Protocol (IP) address and a port number) and a second endpoint device (e.g., the secure virtual gateway appliance 150) associated with a second network address (e.g., and IP address and a port number). A network connection, as used herein, is associated with multiple layers of the Open Systems Interconnection (OSI) model and includes a Transport Control Protocol (TCP) connection.

FIG. 1 uses arrows to depict the directions of network connection initiations for respective network connections. Therefore, as depicted in FIG. 1, for the secure network connections 134 and 135, the BMCs 129 initiate the secure network connections 134 and 135 with the secure virtual gateway appliance 150. In a similar manner, the managed device(s) 199 initiate corresponding secure network connection(s) 154 with the secure virtual gateway appliance 150. Moreover, the secure virtual gateway appliance 150 initiates the persistent network connection 174 with the central management server 180.

The secure virtual gateway appliance 150 includes an aggregator engine 153 that aggregates the bidirectional management network traffic that is communicated between the BMCs 129 and the central management server 180. Moreover, the aggregator engine 153 routes the aggregated directional management traffic through the secure persistent network connection 174. Due to the secure virtual gateway appliance's aggregation of the management network traffic, firewall rules and proxy configurations for the local site 101 are greatly simplified, as compared to the firewall rules and proxy configurations for a site in which BMCs establish respective network connections with a remote, central management server.

In an example, the secure persistent network connection 174 corresponds to a TCP connection and an overlaying WebSocket communication protocol. The WebSocket communication protocol is described in Request for Comments (RFC) publication 6455, entitled, "WebSocket Protocol," which is published by Internet Engineering Task Force (IETF) (December 2011). In an example, the secure persistent network connection 174 further uses a cryptographic protocol, such as a TLS protocol, for authentication and as such, may be referred to as a "WebSocket Secure," or "WSS" connection. The TLS protocol is described in RFC publication 5246, entitled, "The Transport Layer Security (TLS) Protocol Version 1.2," which is published by IETF (August 2008). In accordance with example implementations, the secure persistent network connection 174 uses a mutual TLS, or "mTLS," protocol in which the endpoint devices (here, the secure virtual gateway appliance 150 and the central management server 180) mutually authenticate each other. The mTLS protocol is described in RFC publication 8705, entitled, "OAuth 2.0 Mutual-TLS Client Authentication and Certificate-Bound Access Tokens," which is published by IETF (February 2020).

In accordance with example implementations, the secure persistent network connection 135 is a WebSocket connection that uses the mTLS protocol. In addition to creating a persistent network connection 135 to the secure virtual gateway appliance 150, each BMC 129 may also, over time, form secure short-lived network connections 134 with the secure virtual gateway appliance 150. Unlike a persistent network connection 135, a short-lived network connection 134 is created for a single request-response transaction. In an example, the BMC 129 creates a secure short-lived network connection 134 with the secure virtual gateway appliance 150 for purposes of communicating event-related management network traffic with the central management server 180. In an example, the BMC 129 creates a secure short-lived network connection 134 with the secure virtual gateway appliance 150 for purposes of sending a Representational State Transfer (REST) API request and receiving a corresponding REST API response. In this manner, when the central management server 180 responds with a corresponding REST API response and the virtual gateway appliance 150 forwards the REST API response to the BMC 129, the secure short-lived network connection 134 is then terminated (e.g., terminated by the BMC 129 or terminated by the secure virtual gateway appliance 150).

In an example, a BMC 129 may establish secure short-lived network connections 134 to the secure virtual gateway appliance 150 to send event messages (e.g., Redfish events) to the central management server 180 for purposes of reporting events (e.g., button presses, tampering detections, and out-of-range telemetry values) that are associated with a host 111 that is managed by the BMC 129. In other examples, a BMC 129 may create a secure short-lived network connection 134 with the secure virtual gateway appliance 150 for purposes of requesting and receiving a firmware update or an operating system image update for installation on the managed server 110.

In an example, the secure short-lived network connection 134 is a layer four (L4) TCP connection that uses a layer seven (L7) Hypertext Transfer Protocol Secure (HTTPS) protocol. In accordance with example implementations, the secure short-lived network connection 134 uses the TLS protocol, as described in RFC publication 2818, entitled, "HTTP Over TLS," published by Network Working Group, May 2000. In accordance with example implementations, the secure short-lived network connection 134 is an HTTPS connection that uses the mTLS protocol. Unlike a persistent connection, such as a WebSocket connection, an HTTPS connection is created for purposes of two endpoint devices conducting a single transaction that includes a request (in one direction) and a response (in the other direction). The HTTPS connection is terminated at the conclusion of the transaction.

In accordance with example implementations, each BMC 129 initiates a secure persistent network connection 135 to the same first Uniform Resource Locator (URL), which corresponds to a particular IP address and port of the secure virtual gateway appliance 150. For purposes of forming a secure short-lived network connection 134 with the secure virtual gateway appliance 150, a BMC 129 initiates the connection 134 with a second URL (different from the first URL). In accordance with some implementations, the second URL corresponds to the same IP address and port of the secure virtual gateway appliance 150 as the first URL.

For purposes of establishing an mTLS-based network connection (e.g., a persistent network connection 135 or a short-lived network connection 134), the BMC 129 communicates with the secure virtual gateway appliance 150 using a sequence called an "mTLS handshake." As a broad overview, an mTLS handshake involves the BMC 129 and the secure virtual gateway appliance 150 mutually authenticating each other by exchanging certificates. The BMC 129 and the secure virtual gateway appliance 150 each validates the other device's certificate and verifies a public cryptographic key corresponding to the certificate. Responsive to successful mutual authentication, the BMC 129 and the secure virtual gateway appliance 150 create a session key, an asymmetric cryptographic key, which is used to encrypt and decrypt the network traffic communicated between the BMC 129 and the secure virtual gateway appliance 150.

Turning now to a more detail description of the mTLS handshake, to initiate a secure network connection 134 or 135, the BMC 129 sends an initial message (called the "BMC hello message" herein). The BMC hello message contains information about the BMC 129, such as the highest version of TLS supported by the BMC 129 and a list of cryptographic ciphers supported by the BMC 129. The secure virtual gateway appliance 150 responds to the BMC hello message by sending the BMC 129 an initial message (called the "virtual gateway appliance hello message" herein). The virtual gateway appliance hello message contains information about the secure virtual gateway appliance 150, such as the highest version of TLS supported by the appliance 150 and a list of cryptographic ciphers supported by the appliance 150. The virtual gateway appliance hello message also includes a session identifier (ID).

The secure virtual gateway appliance 150, as part of the mTLS handshake, sends, to the BMC 129, a message containing the secure virtual gateway appliance's TLS certificate, along with any corresponding intermediate certificates. The BMC 129 validates the secure virtual gateway appliance's TLS certificate by verifying the certificate's signature. The secure virtual gateway appliance's TLS certificate contains a public key for the secure virtual gateway appliance. The public key is part of an asymmetric key pair, and the secure virtual gateway appliance 150 should possess the private key of the asymmetric key pair. After validating the secure virtual gateway appliance's TLS certificate, the BMC 129 next determines whether the public key contained in the certificate belongs to the secure virtual gateway appliance 150. For this purpose, the BMC 129 generates a random or pseudorandom secret, encrypts the secret with the secure virtual gateway appliance's public key and sends a message containing the encrypted secret to the secure virtual gateway appliance 150. The secure virtual gateway appliance 150 responds by decrypting the encrypted secret with its private key and sending a message containing the secret (derived from the decryption) to the BMC 129. Upon verifying that the message contains the secret, the BMC 129 determines that the public key contained in the secure virtual gateway appliance's TLS certificate belongs to the secure virtual gateway appliance 150 (and therefore, successfully authenticates the secure virtual gateway appliance 150).

The BMC 129 then, as part of the mTLS handshake, sends, to the secure virtual gateway appliance 150, a message containing the BMC's TLS certificate, along with any corresponding intermediate certificates. In another example, the secure virtual gateway appliance 150 stores any intermediate certificate(s) for the BMC 129, or in another example, retrieves the intermediate certificate(s) from the central management server 180. The secure virtual gateway appliance 150 then validates the BMC's TLS certificate and verifies that the public key contained in the certificate belongs to the BMC 129. This verification is similar to the process described above used by the BMC 129 to verify the secure virtual gateway appliance's public key. After verifying that the public key contained in the BMC's TLS certificate belongs to the BMC 129, the secure virtual gateway appliance 150 then authorizes the mTLS-based connection with the BMC 129. The secure virtual gateway appliance 150 and the BMC 129 then communicate with each other to generate the session key.

In similar manner, the secure virtual gateway appliance 150 may initiate the mTLS-based persistent network connection 174 between the secure virtual gateway appliance 150 and the central management server 180. Moreover, in a similar manner, a managed device 199 may initiate an mTLS-based network connection 154 with the secure virtual gateway appliance 150.

As depicted in FIG. 1, in accordance with example implementations, the secure virtual gateway appliance 150 supports two independent networks: a device network corresponding to a device network fabric 131; and a web network (or "public network") corresponding to a web network fabric 170. The device network fabric 131 connects the BMCs 129 to the secure virtual gateway appliance 150, and the web network fabric 170 connects the secure virtual gateway appliance 150 to the central management server 180. In accordance with example implementations, the device network fabric 131 may be associated with one or multiple types of physical network media and communication networks, including dedicated management networks, local area networks (LANs), wide area networks (WANs), wireless networks, or any combination thereof. In an example, the device network is a private network that complies with RFC publication 1918, entitled, "Address Allocation for Private Internets," which is published by the Network Working Group (February 1996).

In an example, the web network fabric 170 may be associated with multiple types of physical network media and communication networks, LANs, WANs, wireless networks, global networks, or any combination thereof. In accordance with example implementations, the web network fabric 170 includes a firewall that does not allow inbound connections to the system 102, thereby hardening the secure virtual gateway appliance 150 against potential security intrusions.

In accordance with further implementations, the secure virtual gateway appliance 150 is configured with a single network, instead of separate device and web networks.

Among its other features, in accordance with some implementations, the secure virtual gateway appliance 150 includes a forward proxy 155. The forward proxy 155 controls public network connections for the BMCs 129 and controls public network connections for the other managed device(s) 199. More specifically, the forward proxy 155 controls whether the BMCs 129 and other managed device(s) 199 are allowed to connect to selected public network endpoints (e.g., public network endpoints corresponding to a list of allowed URLs).

The secure virtual gateway appliance 150, in accordance with example implementations, executes, or runs, inside a virtual machine 151 that is hosted on a compute node 152 of the system 102. In an example, the compute node 152 corresponds to a managed server 110. In another example, the compute node 152 corresponds to a computer platform other than one of the managed servers 110 and which is located at the site 101.

The compute node 152 includes one or multiple hardware processors. Each hardware processor includes a collection of one or multiple hardware processing cores 160 (e.g., CPU cores). The compute node 152 further includes a memory 162. The memory 162 stores hardware processor-readable instructions 164 that are executed by one or multiple hardware processors for purposes of forming application operating environments of the compute node 152, such as the virtual machine 151. Moreover, instructions 164 may be executed by one or multiple hardware processors for purposes of forming a hypervisor 167 that manages the virtual machine 151 and allocates resources for the virtual machine 151. In an example, the compute node 152 includes a host operating system, and the hypervisor 167 is a type two hypervisor that runs on top of the host operating system. In another example, the hypervisor 167 is a type one hypervisor that runs on bare-metal. The virtual machine 151 has virtual NICs that correspond to the network connections 134, 135, 154 and 174 and are supported by one or multiple underlying physical NICs 166 of the compute node 152. In an example, the virtual machine 151 corresponds to an Open Virtualization Format (OVF) image.

As used herein, an "engine," such as the aggregator engine 153, as well as other engines described herein, can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a CPLD), a programmable gate array (e.g., field programmable gate array (FPGA)), an application specific integrated circuit (ASIC), or another hardware processing circuit. An "engine" can refer to a combination of one or more hardware processing circuits and machine-readable instructions (software and/or firmware) that are executable on the one or more hardware processing circuits. In other examples, an engine can be formed in whole or in part by a CPLD, a PLD, an ASIC, an FPGA or other hardware.

The shared resources 179, which host instances of the central management server 180, include one or multiple processing nodes 185. Each processing node 185, in accordance with example implementations, includes one or multiple processing cores 188 (e.g., CPU cores) and a memory 189. Hardware processors of the processing nodes 185, which may each be formed from one or multiple processing cores 188, execute hardware processor-readable instructions 187 that are stored in the memory 189 for purposes of providing one or multiple instances of the central management server 180. The shared resources 179 may further host other entities that provide services for purposes of managing the managed servers 110 and/or other managed device(s) 199. In an example, as depicted in FIG. 1, in accordance with some implementations, the shared resources 179 host one or multiple instances of remote device access (RDA) servers 183. In an example, an RDA server 183 stores one or multiple certificates for the secure virtual gateway appliance 150, such as a root certificate and one or multiple intermediate certificates. Moreover, an RDA server 183 may store certificates (e.g., intermediate certificates) for the BMCs 129.

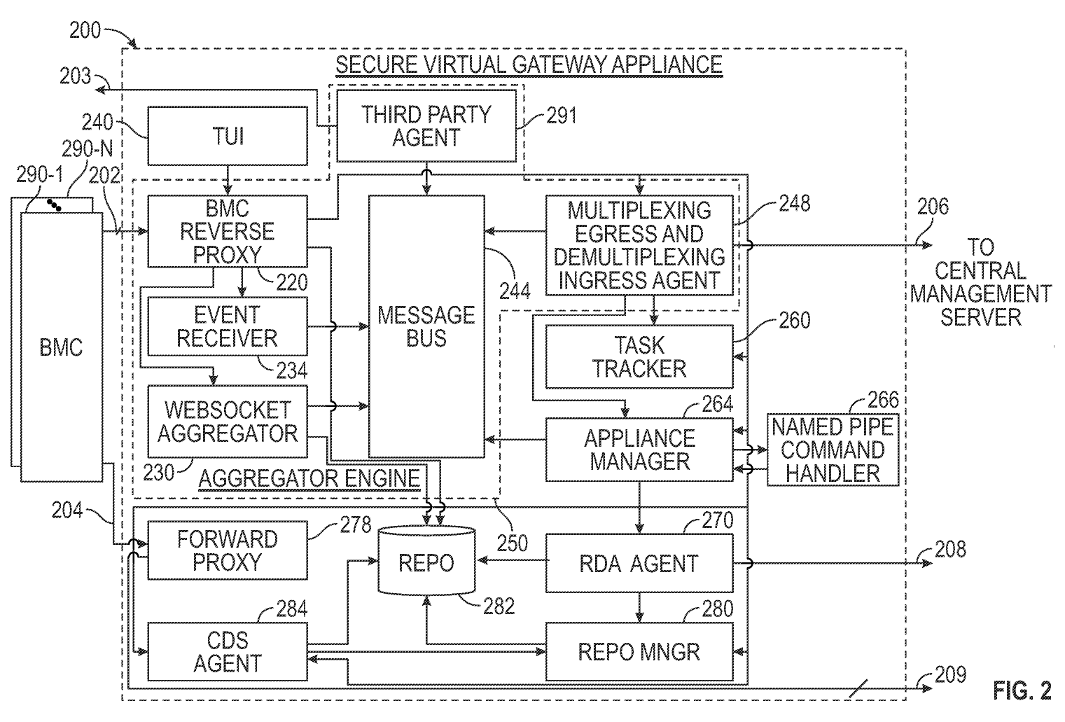

FIG. 2 depicts a block diagram of a secure virtual gateway appliance 200 in accordance with example implementations. Referring to FIG. 2, the secure virtual gateway appliance 200 includes an aggregator engine 250 that aggregates secure network connections corresponding to N BMCs 290 (BMCs 290-1 and 290-N being depicted in FIG. 2) for purposes of routing all bidirectional management traffic between the BMCs 290 and a central management server over a single secure persistent network connection 206. The secure virtual gateway appliance 150 and the BMCs 129 of FIG. 1 are examples of the secure virtual gateway appliance 200 and the BMCs 290, respectively.

Each BMC 290 has one or multiple management traffic-related secure network connections 202 with the secure virtual gateway appliance 200, such as the secure network connections 202 that are depicted in FIG. 2 for the BMC 290-1. A given BMC 290 has a secure persistent network connection 202 with the secure virtual gateway appliance 200, and at a given time, the BMC 290 may also have a secure short-lived network connection 202 with the secure virtual gateway appliance 200. Through the secure network connections 202, the BMCs 290 communicate respective bidirectional management traffic-related flows (called "BMC management traffic-related flows" herein) with the central management server. The aggregator engine 250 aggregates the bidirectional BMC management traffic-related flows into a consolidated bidirectional management traffic-related flow (called the "COM traffic flow" herein). The aggregator engine 250 communicates the COM traffic flow with the central management server via the single secure persistent network connection 206.

The bidirectional BMC management traffic-related flows include ingress flows in a direction from the BMCs 290 and to the secure virtual gateway appliance 200, and the bidirectional BMC management traffic-related flows include egress flows from the secure virtual gateway appliance 200 to the BMCs 290. The aggregator engine 250 receives the ingress traffic flows from the BMCs, and the aggregator engine 250 aggregates the ingress traffic flows to form an egress COM traffic flow. The aggregator engine 250, via the persistent network connection 206, sends the egress COM traffic flow to the central management server. The aggregator engine 250, via the persistent network connection 206, receives an ingress COM traffic flow from the central management server. The aggregator engine 250 disaggregates the ingress COM traffic flow into individual egress traffic flows that the aggregator engine 250 sends, via the network connections 202, to the appropriate BMCs 290.

Due to the connection aggregation provided by the secure virtual gateway appliance 200, the BMCs 290 communicate with the central management server using a single public network connection 206. Consequently, firewall rules and proxy configurations for the local network infrastructure associated with the secure virtual gateway appliance 200 are greatly simplified, as compared to a system in which BMCs individually connect to a central management server.

In an example, the secure persistent network connections are WebSocket with mTLS network connections. In an example, the secure short-lived network connections are HTTPS with mTLS network connections.

The aggregator engine 250, in accordance with example, implementations, includes a message bus 244 and a WebSocket aggregator 230 that is connected to the message bus 244. Although the secure virtual gateway appliance 200 contains components that use the WebSocket communication protocol, in accordance with further implementations, another persistent network connection communication protocol (e.g., long polling, WebTransport, and so forth) may be used. In an example, the message bus 244 is a Neural Autonomic Transport System (NATS) message bus. In other examples, the message bus 244 is a RabbitMQ bus or a Kafka bus. The WebSocket aggregator 230 is an engine that aggregates management network traffic associated with WebSocket connections 202. The WebSocket aggregator 230 consumes, from the message bus 244, published messages corresponding to different ingress traffic flows that are received by the secure virtual gateway appliance 200 and are to be sent, via WebSocket connections 202, to the BMCs 290. Using a BMC reverse proxy 220 of the secure virtual gateway appliance 200, the WebSocket aggregator 230 forwards the consumed messages to the appropriate BMCs 290. The WebSocket aggregator 230 also receives, from the BMC reverse proxy 220, messages corresponding to ingress traffic flows from the BMCs 290 received via the persistent network connections 202. The WebSocket aggregator 230 publishes the messages to the message bus 244.

In accordance with example implementations, the WebSocket aggregator 230 handles network connects and disconnects (e.g., WebSocket connects and disconnects) with the BMCs 290. In accordance with example implementations, for purposes of a BMC 290 establishing a WebSocket connection with the secure virtual gateway appliance 200, the BMC reverse proxy 220 validates a certificate that is provided by the BMC 290 as part of the mTLS handshake. The WebSocket aggregator 230, in accordance with example implementations, gathers information (e.g., a serial number, a product identifier, and so forth) about the BMC 290 from the certificate and supplements message header information about the BMC 290 with the information for the corresponding egress flow to the central management server. The supplemented message header information facilitates the central management server's identification of the BMC 290 and the associated server. The WebSocket aggregator 230, in accordance with example implementations, removes such supplemental header information from message headers of messages from egress flows that are sent to the BMCs 290.

In accordance with example implementations, the WebSocket aggregator 230 rejects persistent connection requests from the BMCs 290 responsive to the secure virtual gateway appliance 200 being disconnected from the central management server. Moreover, in accordance with example implementations, if the secure virtual gateway appliance 200 is disconnected from the central management server for a predetermined time duration (e.g., five minutes or another duration), then the WebSocket aggregator 230 terminates any existing persistent network connections 202. In accordance with example implementations, the WebSocket aggregator 230 sends an acknowledgement message responsive to the sending of a corresponding message. In this manner, responsive to the secure virtual gateway appliance 200 sending a message from a BMC 290 to the central management server, the WebSocket aggregator 230 sends a corresponding acknowledgement message to the BMC 290. Conversely, responsive to the virtual gateway appliance 200 sending a message from the central management server to a BMC 290, the WebSocket aggregator 230 sends a corresponding acknowledgement message to the central management server.

In accordance with example implementations, an event receiver 234 or "event receiver engine" of the aggregator engine 250 is connected to the message bus 244. The event receiver 234 receives, from the BMC reverse proxy 220, messages corresponding to various ingress traffic flows received from the BMCs 290 via the short-lived network connections 202, and the event receiver 234 publishes the received messages to the message bus 244.

In accordance with example implementations, the event receiver 234 handles short-lived network connection terminations and connections with the BMCs 290. In an example, the short-lived network connections are HTTPS connections that use mTLS for authentication, and the BMC reverse proxy 220 validates a certificate provided by the BMC 290 as part of the mTLS handshake. The BMC reverse proxy 220, in accordance with example implementations, gathers information (e.g., a serial number, a product identifier, and so forth) about a BMC 290 from the certificate and supplements message header information about the BMC 290 with the information for the corresponding egress flow to the central management server. The supplemented message header information facilitates the central management server's identification of the BMC 290 and the associated server. In accordance with example implementations, the event receiver 234 terminates a given short-lived network connection 202 responsive to the completion of the corresponding single transaction (e.g., a request being received from a BMC 290 and a corresponding response being sent to the BMC 290).

In accordance with example implementations, the event receiver 234 rejects event connection requests from the BMCs 290 responsive to the secure virtual gateway appliance 200 being disconnected from the central management server.

The aggregator engine 250, in accordance with example implementations, further includes a multiplexing egress and demultiplexing ingress agent 248 (called the "agent 248" or "agent engine 248" herein). The agent 248 is connected to the message bus 244 and consumes messages corresponding to network egress flows that are to be sent to the central management server via the persistent network connection 206. The agent 248 time multiplexes the messages for purposes of forming the egress consolidated network traffic flow that is sent to the central management server via the persistent network connection 206. The agent 248 also demultiplexes messages from the ingress consolidated network traffic flow from the central management server and publishes the messages to the message bus 244.

In accordance with example implementations, the secure virtual gateway appliance 200 includes a third party connection managing agent 291 (called the "third party agent 291" herein) for managed devices (e.g., the managed devices 199 of FIG. 1) other than the BMCs 290. In an example, the BMCs 290, the secure virtual gateway appliance 200 and the central management server are affiliated with the same business entity, and the third party agent 291 is affiliated with another entity. The third party agent 291 forms secure network connections 203 (e.g., secure persistent network connections, secure short-lived network connections, or a combination thereof) with the managed devices. In accordance with example implementations, the third party agent 291 handles secure connects and disconnects with the managed devices. In an example, the secure network connection is a connection that uses mTLS, and the third party agent 291 validates a certificate that is provided by the managed device, and the third party agent 291 provides, to the managed device, a certificate affiliated with the secure virtual gateway appliance 200. In another example, the secure network connection uses TLS. The third party agent 291, in accordance with example implementations, gathers information (e.g., a serial number, a product identifier, and so forth) about a managed device from the certificate that is provided by the managed device, and the third party agent 291 supplements message header information about the managed device for the corresponding egress flow, which is sent to the central management server via the secure persistent network connection 206.

The third party agent 291 publishes messages corresponding to an ingress flow received from a managed device to the message bus 244, and the agent 248 sends the ingress flow to the central management server via the persistent network connection 206. The third party agent 291 consumes, from the message bus 244, messages corresponding to an egress flow for a managed device, and the third party agent 291 sends the egress flow to the managed device.

The secure virtual gateway appliance 200, in accordance with example implementations, includes a task tracker 260 (or "task tracker engine 260"), which logs error events associated with the appliance 200. In an example, the secure virtual gateway appliance 200 may experience an error in connecting with a particular BMC 290 (e.g., the BMC 290 may fail authentication by the secure virtual gateway appliance 200). In another example, the secure virtual gateway appliance 200 may experience an error in connecting with another managed device other than a BMC 290. In other examples, the secure virtual gateway appliance 200 may encounter an error in retrieving a certificate (e.g., an intermediate certificate) for a managed device or BMC 290. In other examples, the secure virtual gateway appliance 200 may experience errors in maintaining or establishing a secure persistent network connection 206 with the central management server. In another example, the secure virtual gateway appliance 200 may encounter an error associated with downloading content, such as a particular firmware image. In another example, the secure virtual gateway appliance 200 may encounter an error connecting to a particular RDA server.

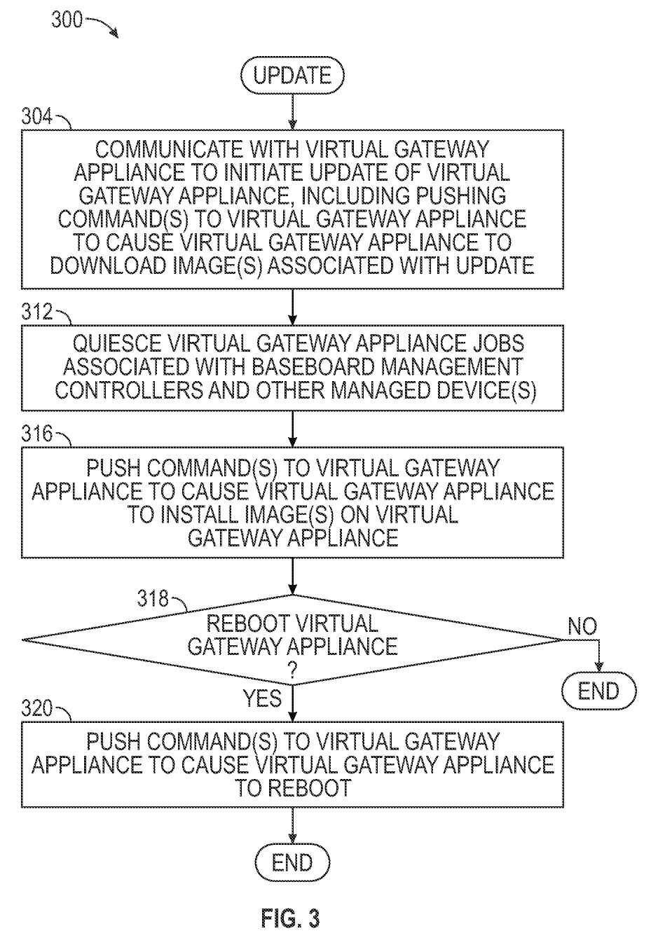

The secure virtual gateway appliance 200, in accordance with example implementations, includes an appliance manager 264 (or "appliance manager engine 264") that the central management server may access for a variety of purposes related to the management of the appliance 200. In an example, the central management server may push commands to the appliance manager 264 for purposes of installing or updating a particular component or components of the secure virtual gateway appliance 200, as further described below in connection with FIG. 3. For purposes of communicating with components of the virtual gateway appliance 200, the appliance manager 264 may use a named pipe handler 266.

Among its other components, the secure virtual gateway appliance 200 includes an RDA agent 270. The RDA agent 270 forms a network connection 208 (e.g., secure persistent connection) with an RDA server (e.g., the RDA server 183 of FIG. 1) for purposes of downloading content for the virtual gateway appliance 200. In an example, the RDA agent 270 may retrieve certificates (e.g., a root certificate and intermediate certificates) for the secure virtual gateway appliance 200. In another example, the RDA agent 270 may, in response to a command pushed to the RDA agent 270 by the central management server, download content corresponding to an update for the secure virtual gateway appliance 200. The RDA agent 270 stores retrieved content in a repository 282 (e.g., a relational database) of the secure virtual gateway appliance 200. The repository 282 is managed by a repository manager 280 of the secure virtual gateway appliance 200.

The secure virtual gateway appliance 200, in accordance with example implementations, includes a content delivery service (CDS) agent 284 (or "CDS agent engine") that, through connections 209 with remote content servers (e.g., the servers 194 of FIG. 1) receives content (e.g., data representing firmware upgrade images, operating system images and/or software patches) to be delivered to the BMCs 290. In accordance with example implementations, the secure virtual gateway appliance 200, requests content from the remote content servers and through the CDS agent 284, the content is downloaded to the repository 282, which serves as a content cache. Later, BMCs 290 may retrieve cached content stored in the repository 282 (e.g., particular firmware images) via short-lived secure network connections 202 with the secure virtual gateway appliance 200.

In accordance with example implementations, in response to a request, from a BMC 290 for certain content, the CDS agent 284 before downloading the requested content, checks with the repository manager 280 for purposes of determining whether the requested content is stored in the repository 282. In this manner, if the content is stored in the repository 282, then the CDS agent 284 retrieves the content from the repository 282 instead of retrieving the content from a remote content server. The local caching of content by the secure virtual gateway appliance 200 may be particularly advantageous when a particular firmware image or operating system image is being used to update all servers in a particular group or is otherwise requested multiple times.

In accordance with example implementations, the secure virtual gateway appliance 200 controls the connections by BMCs 290 to public network-accessible endpoints. A BMC 290, such as exemplary BMC 290-1, may submit a request, via a short-lived connection 204 of the forward proxy 278, to connect to a particular endpoint. In an example, the request may specify a particular URL corresponding to the endpoint. The forward proxy 278 is constructed to allow the BMCs to form forward connections 209 with a restricted collection of endpoints. In an example, the forward proxy 278 is configured with a list of allowed URLs. In response to request, by a BMC 290, to connect to an endpoint identified by a request URL, the forward proxy 278 checks the request URL against the list of allowed URLs. If the request URL is contained in the list of allowed URLs, then the forward proxy 278 allows the BMC 290 to form a connection 209 with endpoint. Otherwise, the forward proxy 278 does not allow the connection.

The virtual gateway appliance 200 further includes a terminal user interface 240, which may be accessed through a secure interface of a hypervisor (e.g., the hypervisor 167 of FIG. 1) for purposes of configuring the network interfaces of the appliance 200.

In accordance with example implementations, the virtual gateway appliance 200 has a microservice-based architecture. As compared to a monolithic application architecture, the services of an application may instead correspond to individual microservices. In accordance with example implementations, all of the components (e.g., the BMC reverse proxy 220, the event receiver 234, the WebSocket aggregator 230, the message bus 244, the third party agent 291, the agent 248, the appliance manager 264, the forward proxy 278, and so forth) are respective microservices. Moreover, in accordance with example implementations, each microservice corresponds to a container that runs inside a container platform, which runs inside a virtual machine (e.g., the virtual machine 151 of FIG. 1) corresponding to the secure virtual gateway appliance 200. In this context, a "container" (which may also be called an "instantiated container," "container instance, or "software container") generally refers to a virtual run-time environment for one or multiple applications and/or application modules, and this virtual run-time environment is constructed to interface to an operating system kernel. A container for a given application may, for example, contain the executable code for the application and its dependencies, such as system tools, libraries, configuration files, executables and binaries for the application. In accordance with example implementations, the container contains an operating system kernel mount interface but does not include the operating system kernel. Docker containers and rkt containers are examples of software containers. An instantiated container is created at load-time from a container image.

FIG. 3 depicts a technique 300 to update a virtual gateway appliance, in accordance with example implementations. In an example, the technique 300 may be performed by a central management server, such as the central management server 180 of FIG. 1. The secure virtual gateway appliance 150 of FIG. 1 and the secure virtual gateway appliance 200 of FIG. 2 are examples of a virtual gateway appliance that may be updated pursuant to the technique 300.

Pursuant to block 304 of the technique 300, the central management server communicates with the virtual gateway appliance to initiate an update of the appliance. In an example, the central management server, via the secure persistent network connection with the virtual gateway appliance, sends an instruction, or command, to an agent (e.g., the agent 248 of FIG. 2) of the virtual gateway appliance, and the agent invokes the appropriate API of an appliance manager (e.g., the appliance manager 264 of FIG. 2) of the virtual gateway appliance. In an example, the central management server initiates the update for purposes of updating one or multiple microservices of the appliance to more recent versions. In another example, the central management server, through inspection of the virtual gateway appliance's task manager log, identifies problems that can be resolved by upgrading or downgrading a microservice of the appliance to a different version. In an example, the initiation of the update causes the virtual gateway appliance to cease forming any new connections with BMCs or other managed devices. In another example, the central management server initiates the update for purposes of installing a more recent operating system image associated with the virtual gateway appliance.

Pursuant to block 304, the initiation of the update includes the central management server pushing one or multiple instructions, or commands, to the virtual gateway appliance. The command(s) cause the appliance manager to initiate a download of one or multiple images corresponding to the update. In this context, the central management server "pushing" a command to the virtual gateway appliance refers to the central management server sending the command to the virtual gateway appliance without the management server being requested or prompted to do so by the virtual gateway appliance.

In an example, the appliance manager handles the response of the virtual gateway appliance to the API call. In a more specific example, the appliance manager acknowledges the API call, and the appliance manager uses a CDS agent (e.g., the CDS agent 284 of FIG. 2) of the virtual gateway appliance to download, from a content server, an image corresponding to the command. In an example, the image is a container image. In another example, the image is an operating system image. In another example, block 304 includes the central management server pushing several commands for purposes of downloading several images to the virtual gateway appliance. In an example, the images may correspond to multiple microservices of the virtual gateway appliance. In an example, the images may be container images. In another example, the images may be a combination of one or multiple container images and an operating system image.

As depicted in block 312 of the technique 300, the central management server quiesces virtual gateway appliance jobs that are associated with the baseboard management controllers and any other devices that are managed by the central management server. In accordance with example implementations, the central management server is the control point for all jobs. Therefore, block 312 includes the central management server waiting for all jobs associated with the virtual gateway appliance to quiesce, and block 312 further includes the central management server pausing any new jobs for the virtual gateway appliance until the update process completes.

In an example, block 312 includes the central management server calling an API, which is handled by the appliance manager. In an example, the appliance manager causes a WebSocket aggregator (e.g., the WebSocket aggregator 230 of FIG. 2) of the virtual gateway appliance to terminate all existing persistent network connections with BMCs and refuse any new persistent network connection until the update is complete. Therefore, the BMCs may establish persistent network connections with the virtual gateway appliance after the update is complete. In another example, the appliance manager causes an event receiver (e.g., the event receiver 234 of FIG. 2) of the virtual gateway appliance to terminate all short-lived network connections with the BMCs and refuse any new short-lived network connections until the update is complete. The BMCs may thereafter initiate and establish short-lived network connections after the update is complete. In another example, the appliance manager causes a third party manager (e.g., the third party manager 291 of FIG. 2) of the virtual gateway appliance to terminate all connections with any other managed device and not make any new managed device connections until the update is complete.

The central management server may then, pursuant to block 316 of the technique 300, push a command to the virtual gateway appliance to install the image(s) that were downloaded by the virtual gateway appliance. In an example, the central management server may wait to proceed with block 316 all jobs associated with the virtual gateway appliance to quiesce. In an example, the central management server, via the secure persistent network connection with the virtual gateway appliance, sends an instruction, or command, to an agent (e.g., the agent 248 of FIG. 2) of the virtual gateway appliance, and the agent invokes the appropriate API of an appliance manager (e.g., the appliance manager 264 of FIG. 2) of the virtual gateway appliance to cause the appliance manager to install the images. The appliance manager acknowledges the API call and takes actions to install the images.

The central management server may then, pursuant to decision block 318, determine whether to reboot the virtual gateway appliance for purposes of completing the update. In an example, the virtual gateway appliance is rebooted responsive to the update containing an updated operating system image, and the virtual gateway appliance is not rebooted otherwise (e.g., not rebooted when the update only involves service images and no operating system image). If, pursuant to decision block 318, the central management server determines to reboot the virtual gateway appliance, then, pursuant to block 320, then the central management server sends a command to the virtual gateway appliance to cause the virtual gateway appliance to reboot. In an example, the central management server, via the secure persistent network connection with the virtual gateway appliance, sends an instruction, or command, to an agent (e.g., the agent 248 of FIG. 2) of the virtual gateway appliance, and the agent invokes the appropriate API of an appliance manager (e.g., the appliance manager 264 of FIG. 2) of the virtual gateway appliance for purposes of causing appliance manager to reboot the virtual gateway appliance. The appliance manager then takes actions to initiate the power down and reboot of the virtual gateway appliance, if needed.

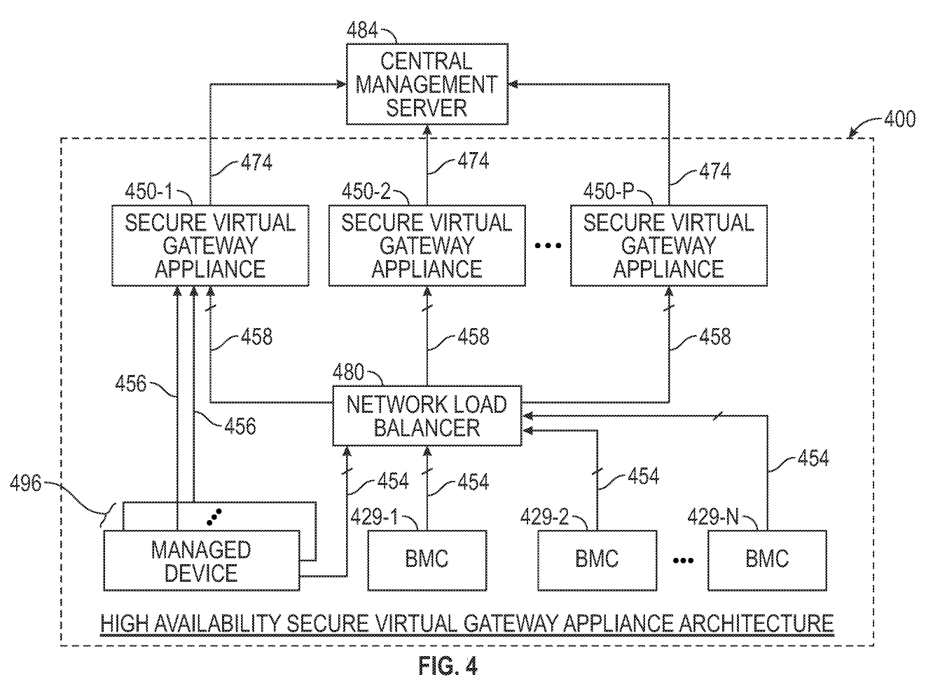

FIG. 4 depicts a high availability (HA) secure virtual gateway appliance architecture 400 in accordance with example implementations. The architecture 400 is co-located with a collection of managed servers and possibly other managed devices 496 that are managed by a central management server 484. In an example, the HA secure virtual gateway architecture 400 may be used in place of the secure virtual gateway appliance 150 of FIG. 1.

The architecture 400 includes P secure virtual gateway appliances 450 (example secure virtual gateway appliances 450-1, 450-2 and 450-P being specifically depicted in FIG. 4) and a network load balancer 480. A collection of N BMCs 429 (example BMCS 429-1, 429-2 and 429-N being specifically depicted in FIG. 4) connect to the secure virtual gateway appliances 450. The network load balancer 480 routes network traffic associated with the BMCs 429 and received at ports 454 of the network load balancer 480, to the secure virtual gateway appliances 450. The network load balancer 480, for each BMC 429, selects a secure virtual gateway appliance 450, and the appliance selection balances network loading associated with network traffic communicated with the central management server 484. Each BMC 429 forms one multiple network connections 458 (e.g., a persistent network connection and over time, short-lived network connections) with the secure virtual gateway appliance 450 that is selected by the network load balancer 480. In an example, the network connection 458 is a secure connection that uses the mTLS protocol for authentication. In a more specific example, a network connection 458 is a short-lived HTTPS connection that uses mTLS for authentication. In another example, a network connection 458 is a persistent WebSocket connection that uses mTLS for authentication.

In an example, in response to recognizing a new BMC 429 (e.g., a server containing the BMC 429 joining the fleet), the network load balancer 480 selects the secure virtual gateway appliance 450 that has the lightest network load among the secure virtual gateway appliances 450. In another example, the network load balancer 480 applies another load balancing-based criteria for purposes of selecting a secure virtual gateway appliance 450 for a particular BMC 429. Moreover, in accordance with example implementations, the network load balancer 480 continually reevaluates the network loads of the secure virtual gateway appliances 450 for purposes of rebalancing the loads, if needed. For example, if the load balancer 480 determines that the load of a given virtual gateway appliance 450 satisfies a certain criteria (e.g., the load exceeds the average network load by a certain percentage or is considered excessive using another criteria), then the network load balancer 480 moves one or multiple BMCs 429 from the given virtual gateway appliance 450 to another virtual gateway appliance 450 that has a relatively lighter network load.

As depicted in FIG. 4, in accordance with some implementations, managed devices 496 other than the BMCs 429 may directly form secure network connections 456 with a particular virtual gateway appliance (e.g., the secure virtual gateway appliance 450-1, as depicted in FIG. 4). However, in accordance with further implementations, the network load balancer 480 or another network load balancer selects the secure virtual gateway appliance(s) 450 for the managed devices 496.

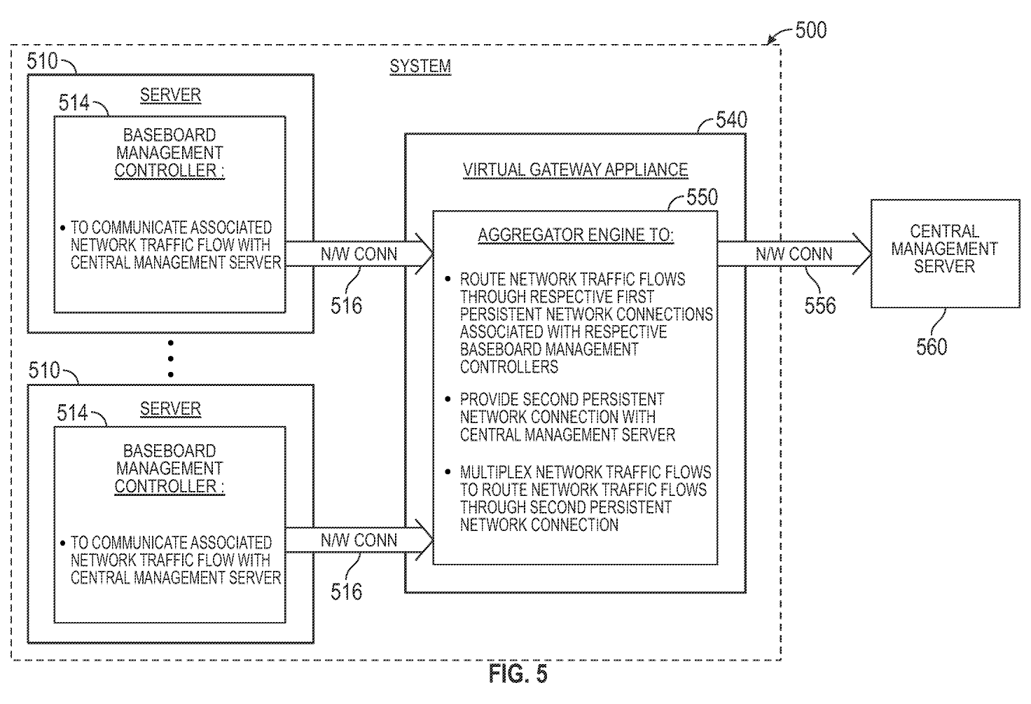

Referring to FIG. 5, in accordance with example implementations, a system 500 includes a plurality of servers 510. Each server 510 includes a baseboard management controller 514. In an example, the server 510 is a blade server. In another example, the server 510 is a rack server. In another example, the server 510 is a tower server. In an example, the system 500 is located at a particular geographical site. In an example, the system 500 is associated with a data center. In another example, the system 500 is an edge computing system. In an example, the baseboard management controller includes a NIC for purposes of communicating with the network. In another example, the baseboard management controller 514 communicates with a network using a sideband channel interface and a NIC adapter of the associated server 510.

Each baseboard management controller 514 communicates an associated network traffic flow with a central management server 560. In an example, the network traffic flow includes event messages (e.g., Redfish events) that the baseboard management controller sends, to the central management server 560, for purposes of reporting events (e.g., button presses, tampering detections, and out-of-range telemetry values) that are associated with a host of the server 510, which is managed by the baseboard management controller 514. In another example, the network traffic corresponds to messaging for purposes of the baseboard management controller 514 receiving a firmware update or a software patch. In another example, the network traffic corresponds to messaging related to the central management server 560 querying the baseboard management controller 514 about a software inventory of the server 510, a hardware inventory of the server 510 and/or a configuration of the host. In other examples, the network traffic corresponds to messaging related to the central management server 560 configuring a host or controlling a host power state.

In accordance with example implementations, the system 500 further includes a virtual gateway appliance 540, which includes an aggregator engine. In an example, the virtual gateway appliance 540 corresponds to a virtual machine. In an example, the virtual machine is hosted by a compute node located at the same geographic site as the servers 510. In an example, the virtual machine hosts microservices. In an example, the microservices correspond to respective containers. In an example, the aggregator engine 550 corresponds to multiple microservices of the virtual gateway appliance. In an example, the aggregator engine 550 includes a microservice corresponding to a reverse proxy, a microservice corresponding to an event receiver, a microservice corresponding to a WebSocket aggregator and a microservice corresponding to a multiplexing egress and demultiplexing ingress agent. In an example, the microservices of the aggregator engine 550 communicate using a message bus of the virtual gateway appliance 540. In an example, the message bus is a NATS-based message bus. In another example, the message bus is a Rabbit-based message bus. In another example, the message bus is a Kafka-based message bus.

The aggregator engine 550 routes the network traffic flows through respective first persistent network connections 516 that are associated with respective baseboard management controllers 514. In an example, a persistent network connection 516 corresponds to a WebSocket connection. In an example, a persistent network connection 516 corresponds to an mTLS authentication protocol. In an example, a network connection 516 endures for multiple request and response transactions. In an example, a network connection 516 endures for a single request and response transaction.

The virtual gateway appliance 540 provides a second persistent network connection 556 with the central management server 560. In an example, the second persistent network connection 556 is a WebSocket connection that uses mTLS for authentication.

The aggregator engine 550 multiplexes the network traffic flows to route the network traffic flows through the second persistent network connection 556. In an example, multiplexing the network traffic flows includes, for a given baseboard management controller 514, routing a request from the baseboard management controller 514 through the second persistent network connection 556 to the central management server 560 and routing a corresponding response, from the central management server 560, back to the given baseboard management controller 514 through the second persistent network connection 556. In another example, the multiplexing includes routing a request, by the central management server 560, to a given baseboard management controller 514 through the persistent network connection 556, and routing a corresponding response, by the baseboard management controller 514 and to the central management server 560, through the second persistent network connection 556. In an example, multiple requests and response transactions associated with multiple baseboard management controllers 514 are multiplexed in time and routed over the second persistent network connection 556.

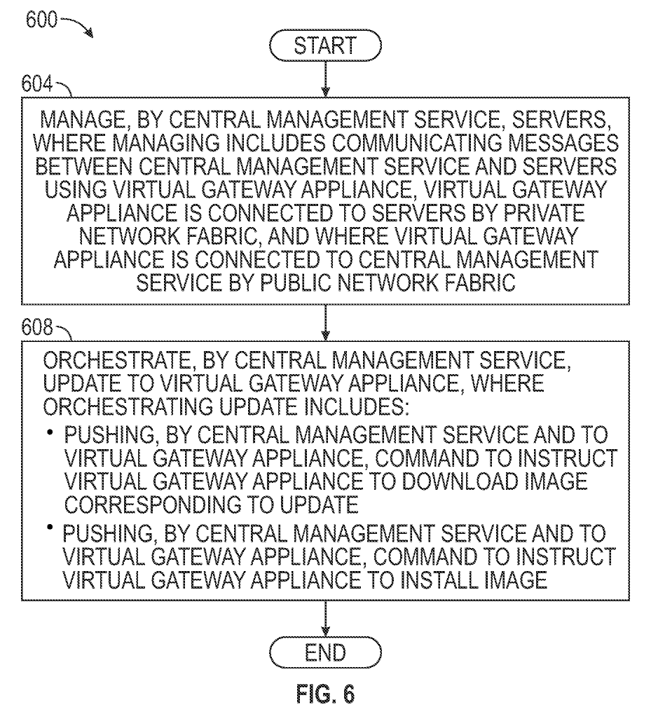

Referring to FIG. 6, in accordance with example implementations, a technique 600 includes managing (block 604), by a central management service, servers. In an example, the central management service manages a health of each of the servers. In an example, the central management service manages inventories of respective servers. In an example, the central management service manages power states of the servers. In an example, the central management service manages firmware updates to the servers. In an example, a server is a rack mount server. In another example, a server is a blade server. In another example, a server is a tower server.

The managing includes communicating messages between the central management service and the servers using a virtual gateway appliance. In an example, the virtual gateway appliance is hosted by a compute node located at the same geographic site as the servers. In an example, the virtual gateway appliance is hosted on one of the servers. In an example, the virtual gateway appliance corresponds to a virtual machine. In an example, the virtual gateway appliance corresponds to a collection of microservices. In an example, each microservice corresponds to a container inside a virtual machine.

In an example, the messages are event-based messages, such as Redfish event messages. In an example, the messages include messages to control a power state of a host of a server. In an example, the messages include messages to query inventories of the servers. In an example, the messages include messages to control configurations of the servers. In an example, the messages include messages to control virtual media for the servers.

The virtual gateway appliance is connected to the servers by private network fabric, and the virtual gateway appliance is connected to the central management service by public network fabric.

Pursuant to block 608, the technique 600 includes orchestrating, by the central management service, an update to the virtual gateway appliance. Orchestrating the update includes pushing, by the central management service and to the virtual gateway appliance, a command to instruct the virtual gateway appliance to download an image that corresponds to the update. In an example, the image is a container image. In an example, the image corresponds to a microservice of the virtual gateway appliance. In another example, the image corresponds to an operating system associated with the virtual gateway appliance.

Orchestration of the update, pursuant to block 608, further includes pushing, by the central management service, a command to instruct the virtual gateway appliance to install the image. In an example, the central management service may first wait for jobs of the virtual gateway appliance to quiese before the central management service pushes the command to cause the virtual gateway appliance to install the image. In an example, central management service may push a command to the virtual gateway appliance to cause the virtual gateway appliance to reboot. In an example, the central management service may reboot the virtual gateway appliance if an operating system image is being installed on the appliance, and otherwise, the central management service does not reboot the virtual gateway appliance (e.g., the central management service does not reboot the virtual gateway appliance if no operating system image is being installed).

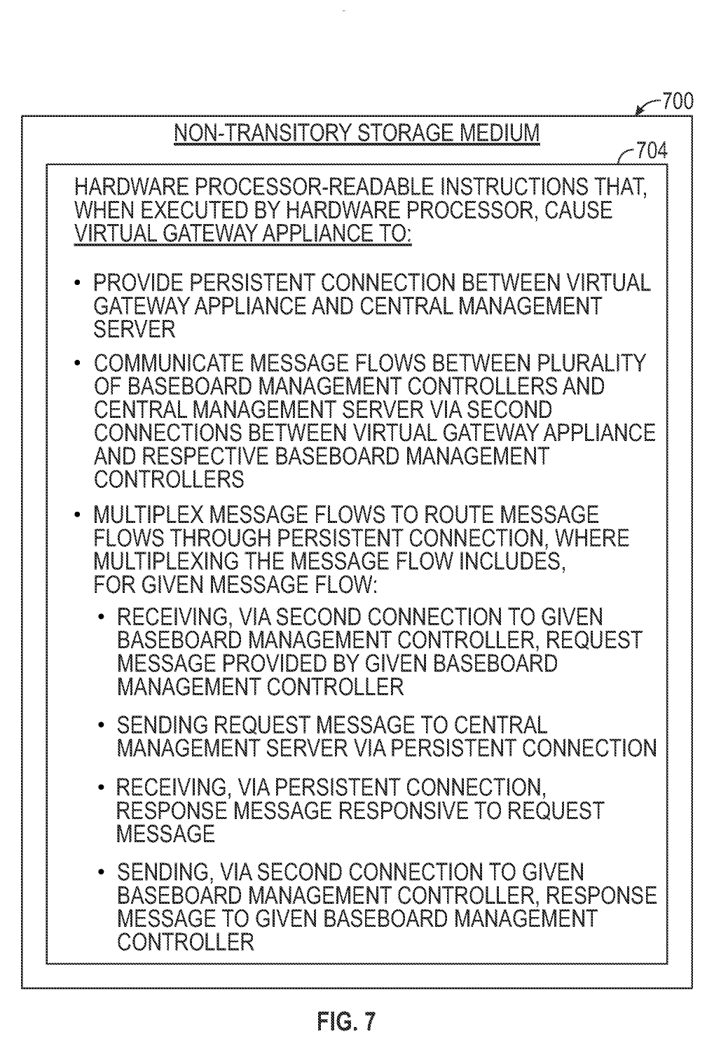

Referring to FIG. 7, in accordance with example implementations, a non-transitory storage medium 700 stores hardware processor-readable instructions 704. In an example, the non-transitory storage medium 700 is a memory. In an example, the non-transitory storage medium 700 is a memory of a compute node of a geographical site containing servers that are managed by a central management server. In an example, the hardware processor is a collection of one or multiple CPU cores.

The instructions 704, when executed by the hardware processor, cause a virtual gateway appliance to provide a persistent connection between the virtual gateway appliance and a central management server. In an example, the virtual gateway appliance corresponds to a virtual machine. In an example, the virtual gateway appliance corresponds to a collection of microservices that are hosted in the virtual machine. In an example, the microservices are contained in respective containers. In an example, the persistent connection is a WebSocket connection that uses the mTLS protocol for authentication.

The instructions 704, when executed by the hardware processor, further cause the virtual gateway appliance to communicate message flows between a plurality of baseboard management controllers and a central management server via second connections between the virtual gateway appliance and respective baseboard management controllers. In an example, the second connections are persistent connections. In an example, the second connections are WebSocket connections. In an example, the WebSocket connections use the mTLS protocol for authentication. In an example, the second connections include one or multiple short-lived mTLS-based connections. In an example, the baseboard management controllers initiate mTLS handshakes with the virtual gateway appliance to form the second connections.

The instructions 704, when executed by the hardware processor, further cause the virtual gateway appliance to multiplex the message flows to route the message flows through the persistent connection with the central management server. In an example, multiplexing the message flows include communicating the message flows at different respective times. Multiplexing the message flow includes, for a given message flow, receiving, via the second connection to a given baseboard management controller, a request message provided by the given baseboard management controller and sending the request message to the central management server via the persistent connection. In an example, the request is a Redfish event request. In another example, the request reports an out-of-range telemetry value. In another example, the request reports tampering with a server. In another example, a request initiates a firmware upgrade for a server. In another example, the request initiates a software patch.

Multiplexing the message flow includes, for the given message flow, receiving, via the persistent connection with the central management server, a response message, which is responsive to the request message. In an example, the response message is an acknowledgment. In an example, the response message includes a URL for a firmware or software download. Multiplexing the message flows further includes, for the given message flow, sending, via the second connection to the given baseboard management controller, the response message to the given baseboard management controller.

In accordance with example implementations, the virtual gateway appliance includes a temporary connection aggregator engine. The temporary connection aggregator engine to route an additional network traffic flow associated with a given baseboard management controller in through an associated third connection and out through the second persistent network connection. The temporary connection aggregator engine to further, responsive to delivery of a response message associated with the additional network traffic flow, terminate the third connection. Among the particular advantages, a collection of servers at a particular geographical site may communicate management-related traffic with compute operations management services using a single public network WebSocket connection, thereby simplifying firewall and proxy configurations.

In accordance with example implementations, the system further includes a compute node to host a virtual machine. The virtual gateway appliance executes inside the virtual machine. Among the particular advantages, a collection of servers at a particular geographical site may communicate management-related traffic with compute operations management services using a single public network WebSocket connection, thereby simplifying firewall and proxy configurations.

In accordance with example implementations, the system further includes a plurality of containers hosted by a container platform that is hosted by the virtual machine. The virtual gateway appliance includes microservices hosted by respective containers of the plurality of containers. Among the particular advantages, a collection of servers at a particular geographical site may communicate management-related traffic with compute operations management services using a single public network WebSocket connection, thereby simplifying firewall and proxy configurations.

In accordance with example implementations, the system further includes a second virtual gateway appliance. The second virtual gateway appliance to provide associated third persistent network connections associated with additional baseboard management controllers. Each additional baseboard management controller communicates an associated network traffic flow with the central management server. Among the particular advantages, a collection of servers at a particular geographical site may communicate management-related traffic with compute operations management services using a single public network WebSocket connection, thereby simplifying firewall and proxy configurations.

In accordance with example implementations, the system further includes a network load balancer. The network load balancer to, based on a network load associated with the first virtual gateway appliance and a network load associated with the second virtual gateway appliance, select the first virtual gateway appliance for a first baseboard controller of the plurality of baseboard management controllers. The network load balancer to further, responsive to the selection, direct the network traffic flow associated with the first baseboard controller to the first virtual gateway appliance. Among the particular advantages, a collection of servers at a particular geographical site may communicate management-related traffic with compute operations management services using a single public network WebSocket connection, thereby simplifying firewall and proxy configurations.

In accordance with example implementations, the virtual gateway appliance further includes a forward proxy. The forward proxy to control whether a given baseboard management controller is allowed to connect to a second server responsive to a uniform resource locator (URL) associated with the second server being in a collection of approved URLs. Among the particular advantages, a collection of servers at a particular geographical site may communicate management-related traffic with compute operations management services using a single public network WebSocket connection, thereby simplifying firewall and proxy configurations.

In accordance with example implementations, the first virtual gateway appliance and a given baseboard management controller perform authentication based on an mTLS handshake. The given baseboard management controller, pursuant to the mTLS handshake, receives, from the first virtual gateway appliance, a first certificate provided by the first virtual gateway appliance. The given baseboard management controller, pursuant to the mTLS handshake and responsive to the baseboard management controller verifying the first certificate, provides, to the first virtual gateway appliance, a second certificate. The first virtual gateway appliance, pursuant to the mTLS handshake and responsive to the first virtual gateway appliance verifying the second certificate, allows the associated first persistent network connection with the given baseboard management controller. Among the particular advantages, a collection of servers at a particular geographical site may communicate management-related traffic with compute operations management services using a single public network WebSocket connection, thereby simplifying firewall and proxy configurations.

In accordance with example implementations, the virtual gateway appliance further includes a managed device connection aggregator engine. The managed device connection aggregator engine provides a third connection associated with a managed device other than the plurality of baseboard management controllers. The managed device communicates an associated network traffic flow with the central management server. The managed device connection aggregator engine multiplexes the network traffic flow associated with the managed device with the network traffic flows associated with the plurality of baseboard management controllers to route the network traffic flow associated with the managed device through the second persistent network connection. Among the particular advantages, a collection of servers at a particular geographical site may communicate management-related traffic with compute operations management services using a single public network WebSocket connection, thereby simplifying firewall and proxy configurations.

In accordance with example implementations, the virtual gateway appliance includes a repository, and a first network traffic flow of the network traffic flows includes a content. The virtual gateway appliance further includes a content delivery engine to store the content in the repository and responsive to a request associated with a second network traffic flow requesting the content, access the repository and serve the request with the content. Among the particular advantages, a collection of servers at a particular geographical site may communicate management-related traffic with compute operations management services using a single public network WebSocket connection, thereby simplifying firewall and proxy configurations.

In the context that is used herein, a BMC is a specialized service processor that monitors the physical state of a server or other hardware using sensors and communicates with a management system through a management network. The BMC may also communicate with applications executing at the operating system level through Input and Output Control (IOCTL) interface drivers, REST API calls, or some other system software proxy that facilitates communication between the BMC and applications. The BMC may have hardware level access to hardware devices that are located in a server chassis including system memory. The BMC may be able to directly modify the hardware devices. The BMC may operate independently of the operating system of the system in which the BMC is disposed. A BMC may be located on the motherboard or main circuit board of the server or other device to be monitored.

The fact that a BMC is mounted on a motherboard of the managed server/hardware or otherwise connected or attached to the managed server/hardware does not prevent the BMC from being considered “separate” from the server/hardware. As used herein, BMC has management capabilities for sub-systems of a computing device, and is separate from a processing resource that executes an operating system of a computing device. The BMC is separate from a processor, such as a central processing unit, which executes a high-level operating system or hypervisor on a system.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening element, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A system comprising:
a plurality of servers, wherein:
the plurality of servers comprises a plurality of baseboard management controllers;
each server of the plurality of servers comprises a baseboard management controller of the plurality of baseboard management controllers; and
each baseboard management controller of the plurality of baseboard management controllers to communicate an associated network traffic flow with a central management server; and
a first virtual gateway appliance comprising an aggregator engine, wherein the aggregator engine to:
route the network traffic flows through respective first persistent network connections associated with respective baseboard management controllers of the plurality of baseboard management controllers;
provide a second persistent network connection with the central management server; and
multiplex the network traffic flows to route the network traffic flows through the second persistent network connection.

2. The system of claim 1, wherein the first virtual gateway appliance further comprising a temporary connection aggregator engine, wherein the temporary connection aggregator engine to:
route an additional network traffic flow associated with a given baseboard management controller of the plurality of baseboard management controllers in through an associated third connection and out through the second persistent network connection; and
responsive to delivery of a response message associated with the additional network traffic flow through the third connection, terminate the third connection.

3. The system of claim 1, further comprising:
a compute node to host a virtual machine, wherein the first virtual gateway appliance executes inside the virtual machine.

4. The system of claim 3, further comprising a plurality of containers hosted by the virtual machine, wherein the virtual gateway appliance comprises microservices hosted by respective containers of the plurality of containers.

5. The system of claim 1, further comprising, a second virtual gateway appliance other than the first virtual gateway appliance, wherein:
the second virtual gateway appliance to provide associated third persistent network connections associated with additional baseboard management controllers other than the plurality of baseboard management controllers, wherein each additional baseboard management controller of the additional baseboard management controllers communicates an associated network traffic flow with the central management server.

6. The system of claim 5, further comprising:
a network load balancer to:
based on a network load associated with the first virtual gateway appliance and a network load associated with the second virtual gateway appliance, select the first virtual gateway appliance for a first baseboard controller of the plurality of baseboard management controllers; and
responsive to the selection, direct the network traffic flow associated with the first baseboard management controller to the first virtual gateway appliance.

7. The system of claim 1, wherein the first virtual gateway appliance further comprises:
a forward proxy to control whether a given baseboard management controller of the plurality of baseboard management controllers is allowed to connect to a second server other than the central management server responsive to a uniform resource locator (URL) associated with the second server being in a collection of approved URLs.

8. The system of claim 1, wherein:
the first virtual gateway appliance and a given baseboard management controller of the plurality of baseboard management controllers perform authentication based on a mutual Transport Layer Security (mTLS) handshake;
the given baseboard management controller, pursuant to the mTLS handshake, receives, from the first virtual gateway appliance, a first certificate provided by the first virtual gateway appliance;
the given baseboard management controller, pursuant to the mTLS handshake and responsive to the baseboard management controller verifying the first certificate, provides, to the first virtual gateway appliance, a second certificate; and
the first virtual gateway appliance, pursuant to the mTLS handshake and responsive to the first virtual gateway appliance verifying the second certificate, allows the associated first persistent network connection with the given baseboard management controller.

9. The system of claim 1, wherein the first virtual gateway appliance further comprises a managed device connection aggregator engine to:
provide a third connection to a managed device other than the plurality of baseboard management controllers, wherein the managed device communicates an associated network traffic flow with the central management server; and
multiplex the network traffic flow associated with the managed device with the network traffic flows associated with the plurality of baseboard management controllers to route the network traffic flow associated with the managed device through the second persistent network connection.

10. The system of claim 1, wherein:
first virtual gateway appliance comprises a repository;
a first network traffic flow of the network traffic flows includes a content; and
the first virtual gateway appliance further comprises a content delivery engine to:
store the content in the repository; and
responsive to a request associated with a second network traffic flow of the network traffic flows requesting the content, access the repository and serve the request with the content.

11. A method comprising:
managing, by a central management service, servers, wherein the managing comprises communicating messages between the central management service and the servers using a virtual gateway appliance, wherein the virtual gateway appliance is connected to the servers by a private network, and wherein the virtual gateway appliance is connected to the central management service by a public network fabric; and
orchestrating, by the central management service, an update to the virtual gateway appliance, wherein orchestrating the update comprises:
pushing, by the central management service and to the virtual gateway appliance, a command to instruct the virtual gateway appliance to download an image corresponding to the update; and
pushing, by the central management service and to the virtual gateway appliance, a command to instruct the virtual gateway appliance to install the image.

12. The method of claim 11, wherein orchestrating the update further comprises at least one of:
waiting, by the central management service, for the virtual gateway appliance to quiesce operations associated with processing the messages; or
waiting, by the central management service, for operations of the virtual gateway appliance to quiese.

13. The method of claim 11, wherein orchestrating the update further comprises pushing, by the central management service and to the virtual gateway appliance, a command to cause the virtual gateway appliance to reboot the virtual gateway appliance.

14. The method of claim 11, wherein orchestrating the update comprises adding or replacing a microservice to the virtual gateway appliance, and the method further comprises downloading, by the virtual gateway appliance, a container image corresponding to the microservice.

15. A non-transitory storage medium that stores hardware processor-readable instructions that, when executed by a hardware processor, cause a virtual gateway appliance to:
provide a persistent connection between the virtual gateway appliance and a central management server;
communicate message flows between a plurality of baseboard management controllers and the central management server via second connections between the virtual gateway appliance and respective baseboard management controllers of the plurality of baseboard management controllers; and
multiplex the message flows to route the message flows through the persistent connection, wherein multiplexing the message flow comprises, for a given message flow of the message flows:
receiving, via the second connection to a given baseboard management controller of the plurality of baseboard management controllers, a request message provided by the given baseboard management controller;
sending the request message to the central management server via the persistent connection;
receiving, via the persistent connection, a response message responsive to the request message; and
sending, via the second connection to the given baseboard management controller, the response message to the given baseboard management controller.

16. The storage medium of claim 15, wherein the instructions, when executed by the hardware processor, further cause the virtual gateway appliance to:
receive, via the persistent connection, a second request message provided by the central management server;
send the second request message to the given baseboard management controller via the second connection to the given baseboard management controller;
receive, via the second connection to the given baseboard management controller, a second response message responsive to the second request message; and
send, via the persistent connection, the second response message to the central management server.

17. The storage medium of claim 15, wherein the instructions, when executed by the hardware processor, further cause the virtual gateway appliance to:
receive, via the second connection to a second baseboard management controller of the plurality of baseboard management controllers other than the given baseboard management controller, a second request message provided by the second baseboard management controller;
send the second request message to the central management server via the persistent connection;
receive, via the persistent connection, a second response message responsive to the second request message; and
send, via the second connection to the second baseboard management controller, the second response message to the second baseboard management controller.

18. The storage medium of claim 15, wherein:
the second connection to the given baseboard management controller comprises a non-persistent connection; and
the instructions, when executed by a hardware processor, further cause the virtual gateway appliance to terminate the second connection to the given baseboard management controller responsive to the sending of the second response message to the central management server.

19. The storage medium of claim 15, wherein:
the second connection to the given baseboard management controller comprises a persistent connection; and
the instructions, when executed by the hardware processor, further cause the virtual gateway appliance to maintain the second connection to the given baseboard management controller responsive to the sending of the second response message to the central management server.

20. The storage medium of claim 15, wherein:
the second connection to the given baseboard management controller comprises a mutual Transport Layer Protocol (mTLS)-based connection; and
the persistent connection comprises an mTLS-based connection.
